(19) United States
(12) Patent Application Publication
(10) Pub. No.: US 2018/0081861 A1
(43) Pub. Date: Mar. 22, 2018

(54) SMART DOCUMENT BUILDING USING NATURAL LANGUAGE PROCESSING

(71) Applicant: ABBYY InfoPoisk LLC, Moscow (RU)

(72) Inventor: Tatiana Vladimirovna Danielyan, Moscow (RU)

(21) Appl. No.: 15/277,187

(22) Filed: Sep. 27, 2016

(30) Foreign Application Priority Data
Sep. 22, 2016 (RU) 2016137780

(51) Int. Cl. G06F 17/21; G06F 17/27; G06F 3/0482

(52) U.S. Cl. CPC G06F 17/212; G06F 17/2785; G06F 3/0482; G06F 17/278; G06F 17/271

(57) ABSTRACT

A smart document generator receives a natural language text that comprises a plurality of text regions, performs natural language processing analysis of the natural language text to determine one or more semantic relationships within the plurality of text regions, generates a search query based on the results of the natural language processing to search for additional content related to at least one text region of the plurality of text regions, and transmits the search query to available information resources. Upon receiving additional content items that each relate to a respective text region in response to the search query, a combined document is generated that includes a plurality of portions, each of the plurality of portions comprising one of the plurality of text regions, and at least one of the plurality of portions further comprising one or more of the plurality of additional content items that relate to a respective text region.

### CROSS REFERENCE TO RELATED APPLICATIONS

The present application claims the benefit of priority under 35 USC 119 to Russian Patent Application No. 2016137780, filed Sep. 22, 2016; disclosure of which is incorporated herein by reference in its entirety for all purposes.

### TECHNICAL FIELD

The present disclosure is generally related to computer systems, and is more specifically related to systems and methods for creating documents using natural language processing.

### BACKGROUND

Information extraction is one of the important operations in automated processing of natural language texts. In natural language processing, text segmentation divides source text into meaningful units, such as words, sentences, or topics. Sentence segmentation divides a string of written language into its component sentences. In a document that includes multiple topics, topic segmentation can analyze the sentences of the document to identify the different topics based on the meanings of the sentences, and subsequently segment the text of the document according to the topic.

### SUMMARY OF THE DISCLOSURE

In accordance with one or more aspects of the present disclosure, an example method may comprise: receiving a natural language text that comprises a plurality of text regions, performing natural language processing of the natural language text to determine one or more semantic relationships for the plurality of text regions, generating a search query based on the results of the natural language processing to search for additional content related to at least one text region of the plurality of text regions, and transmitting the search query to available information resources. Upon receiving additional content items that each relate to a respective text region in response to the search query, a combined document is generated that includes a plurality of portions, each portion comprising one of the plurality of text regions, and at least one of the plurality of portions further comprising one or more of the plurality of additional content items that relate to a respective text region.

In accordance with one or more aspects of the present disclosure, an example system may comprise: a memory; and a processor, coupled to the memory, wherein the processor is configured to: receive a natural language text that comprises a plurality of text regions, perform natural language processing of the natural language text to determine one or more semantic relationships within the plurality of text regions, generate a search query based on the results of the natural language processing to search for additional content related to at least one text region of the plurality of text regions, and transmit the search query to available information resources. Upon receiving additional content items that each relate to a respective text region in response to the search query, a combined document is generated that includes a plurality of portions, each of the plurality of portions comprising one of the plurality of text regions, and at least one of the plurality of portions further comprising one or more of the plurality of additional content items that relate to a respective text region.

In accordance with one or more aspects of the present disclosure, an example computer-readable non-transitory storage medium may comprise executable instructions that, when executed by a computing device, cause the computing device to: receive a natural language text that comprises a plurality of text regions, perform natural language processing of the natural language text to determine one or more semantic relationships within the plurality of text regions, generate a search query based on the results of the natural language processing to search for additional content related to at least one text region of the plurality of text regions, and transmit the search query to available information resources. Upon receiving additional content items that each relate to a respective text region in response to the search query, a combined document is generated that includes a plurality of portions, each of the plurality of portions comprising one of the plurality of text regions, and at least one of the plurality of portions further comprising one or more of the plurality of additional content items that relate to a respective text region.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level diagram of an example smart document generator, in accordance with one or more aspects of the present disclosure.

FIG. 2 depicts a flow diagram of a method for generating a combined document using natural language processing, in accordance with one or more aspects of the present disclosure.

FIG. 3 depicts a flow diagram of a method for performing natural language processing of a natural language text to determine semantic relationships, in accordance with one or more aspects of the present disclosure.

FIG. 4 depicts a flow diagram of a method for generating a combined document, in accordance with one or more aspects of the present disclosure.

FIG. 5 depicts a flow diagram of one illustrative example of a method 500 for performing a semantico-syntactic analysis of a natural language sentence, in accordance with one or more aspects of the present disclosure.

FIG. 6 schematically illustrates an example of a lexico-morphological structure of a sentence, in accordance with one or more aspects of the present disclosure.

FIG. 7 schematically illustrates language descriptions representing a model of a natural language, in accordance with one or more aspects of the present disclosure.

FIG. 8 schematically illustrates examples of morphological descriptions, in accordance with one or more aspects of the present disclosure.

FIG. 9 schematically illustrates examples of syntactic descriptions, in accordance with one or more aspects of the present disclosure.

FIG. 10 schematically illustrates examples of semantic descriptions, in accordance with one or more aspects of the present disclosure.

FIG. 11 schematically illustrates examples of lexical descriptions, in accordance with one or more aspects of the present disclosure.

FIG. 12 schematically illustrates example data structures that may be employed by one or more methods implemented in accordance with one or more aspects of the present disclosure.

FIG. 13 schematically illustrates an example graph of generalized constituents, in accordance with one or more aspects of the present disclosure.

FIG. 14 illustrates an example syntactic structure generated from the graph of generalized constituents corresponding to the sentence illustrated by FIG. 13.

FIG. 15 illustrates a semantic structure corresponding to the syntactic structure of FIG. 14.

FIG. 15A illustrates an example of establishing relationships within a set of sentences.

FIG. 15B illustrates a fragment of a semantic hierarchy comprising semantic classes for information objects of the sentences of FIG. 15A.

FIG. 15C depicts an example of an illustrated fragment of the text for the sentences of FIG. 15A, in accordance with one or more aspects of the present disclosure.

FIG. 15D depicts an example of an illustrated fragment of text, in accordance with one or more aspects of the present disclosure.

FIG. 16 depicts a block diagram of an illustrative computer system operating in accordance with examples of the present disclosure.

### DETAILED DESCRIPTION

Described herein are methods and systems for smart document building using natural language analysis of natural language text. Creating illustrated texts or adding additional content to presentations can sometimes involve extensive manual effort by a user in the form of formatting the text as well as manual searching for the additional content. When using computer based searching methods such as searching a local data store or searching for resources available over the Internet using an Internet based search engine, a user may often conduct repeated searches before finding anything relevant to the subject matter of the document. Additionally, the user may not be able to formulate a search query that is likely to capture the most meaningful additional content. This can often be the case when a user requests a search only using a particular topic keyword or phrase, rather than searching for semantically, syntactically, or lexically similar words or phrases.

Aspects of the present disclosure address the above noted and other deficiencies by employing natural language processing mechanisms to identify the meaning of text in a document and perform directed searches for additional content that may be used to augment the contents of the text document. In an illustrative example, a smart document generator may receive a natural language text document as input for the creation of a combined document such as a presentation or illustrated text. The smart document generator may determine the semantic, syntactic, and lexical relationships between sentences of the natural language text document and use that information to divide the natural language text into meaningful segments (e.g., separating the text by topic, sub-topic, etc.). The smart document generator may then use the identified relationships to construct detailed search queries for each of the segments so that additional content items that are most relevant to the contents of the segment may be identified and subsequently combined with the text to generate a combined document.

Aspects of the present disclosure are thus capable of more efficiently identifying and retrieving meaningful additional content for a text document with little to no user intervention. Moreover, the text document can be more efficiently divided into logical portions or segments based on the identified relationships between the sentences, thereby reducing or eliminating the resources needed for document creation and/or modification.

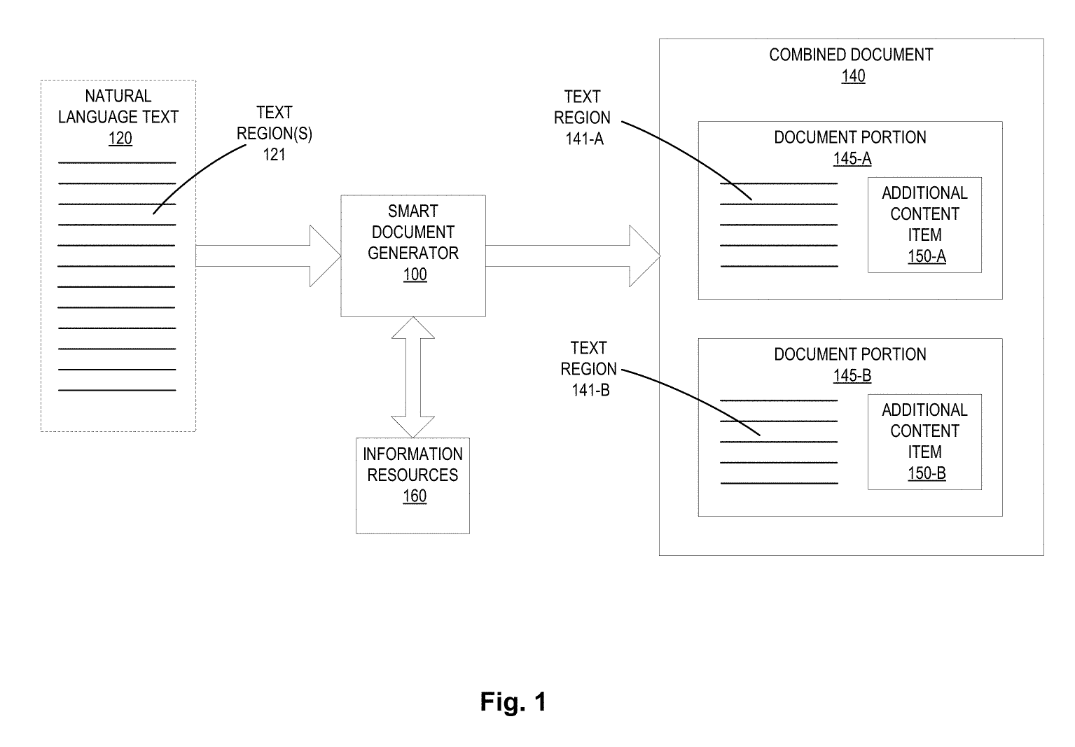

FIG. 1 depicts a high-level component diagram of an example smart document generation system in accordance with one or more aspects of the present disclosure. The smart document generation system may include a smart document generator 100 and information resources 160. The smart document generator 100 may be a client-based application or may be a combination of a client component and a server component. In some implementations, the smart document generator 100 may execute entirely on the client computing device such as a tablet computer, a smart phone, a notebook computer, a camera, a video camera, or the like. Alternatively, the client component of the smart document generator 100 executing on the client computing device may receive the natural language text and transmit it to the server component of the smart document generator 100 executing on a server device that performs the natural language processing and document generation. The server component of the smart document generator 100 may then return the combined document to the client component of the smart document generator 100 executing on the client computing device. In other implementations, smart document generator 100 may execute on a server device as an Internet-enabled application accessible via a browser interface. The server device may be represented by one or more computer systems such as one or more server machines, workstations, mainframe machines, personal computers (PCs), etc.

In an illustrative example, smart document generator 100 may receive a natural language text 120. In one embodiment, smart document generator 100 may receive the natural language text via a text entry application, a pre-existing document that includes textual content (e.g., a text document, a word processing document, an image document that has undergone optical character recognition (OCR), or in any similar manner. Alternatively, smart document generator 100 may receive an image of text (e.g., via a camera of a mobile device), subsequently performing optical character recognition (OCR) on the image. Smart document generator 100 may also receive an audio dictation from a user (e.g., via a microphone of the computing device) and convert the audio to text via a transcription application.

A text may be initially divided into a set of regions—parts, paragraphs, but sometimes, for example, for presentations, there is a task to divide the text into more small regions. A text region may be a portion of the natural language text where the sentences in that portion are related to each other in structure or content. In some implementations, a text region may be identified in the natural language text by a particular indicator such as a new paragraph (e.g., a control character indicating a new paragraph), a new line for a list of sentences, an indicator in a delimited file (e.g., an Extensible Markup Language (XML) indicator in an XML-delimited file), or in any similar manner.

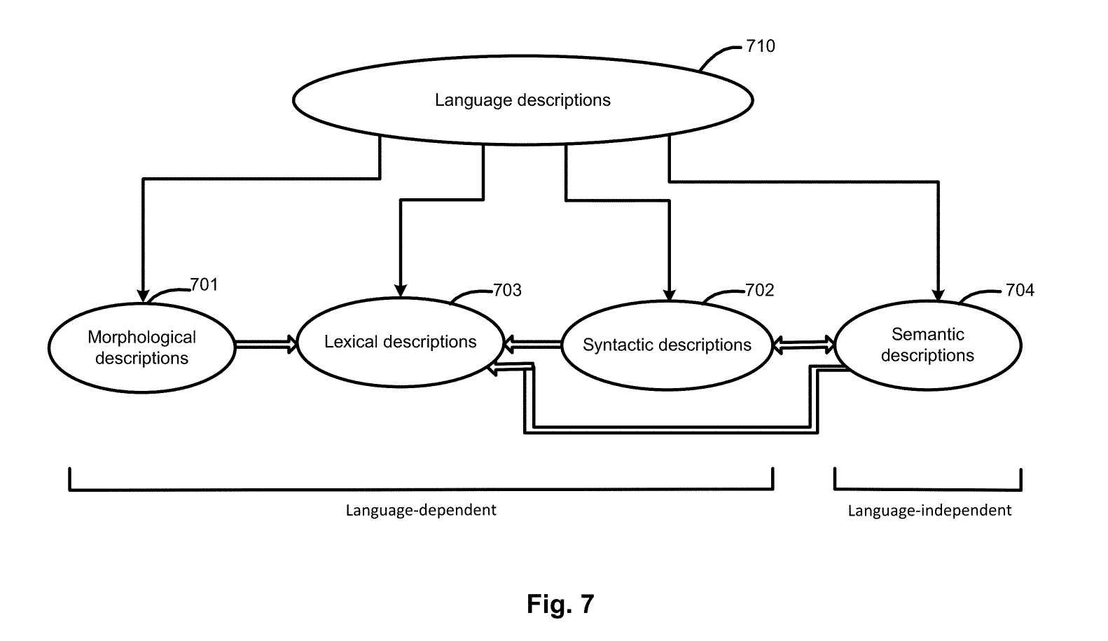

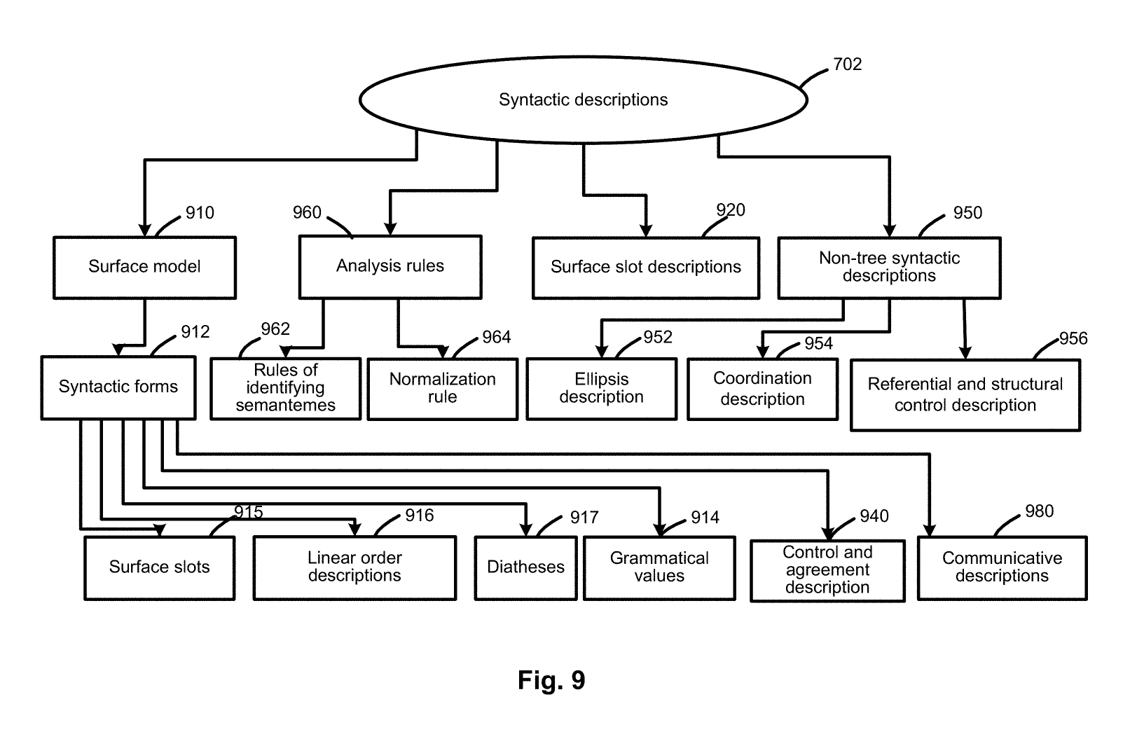

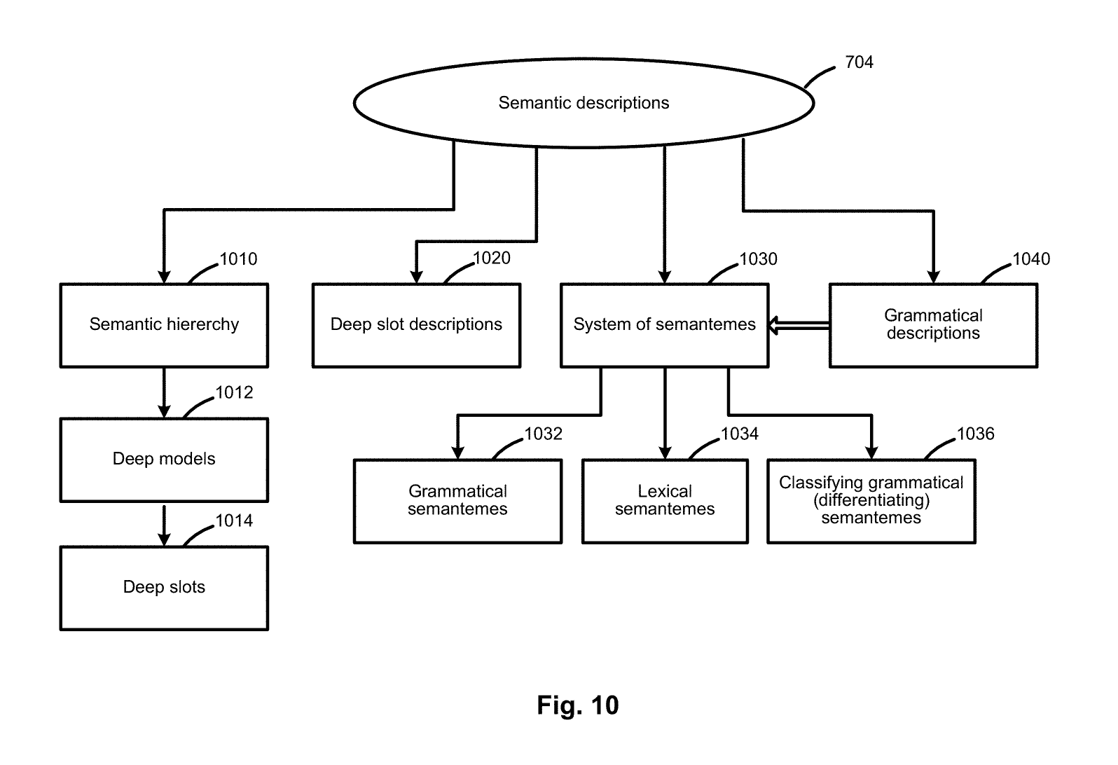

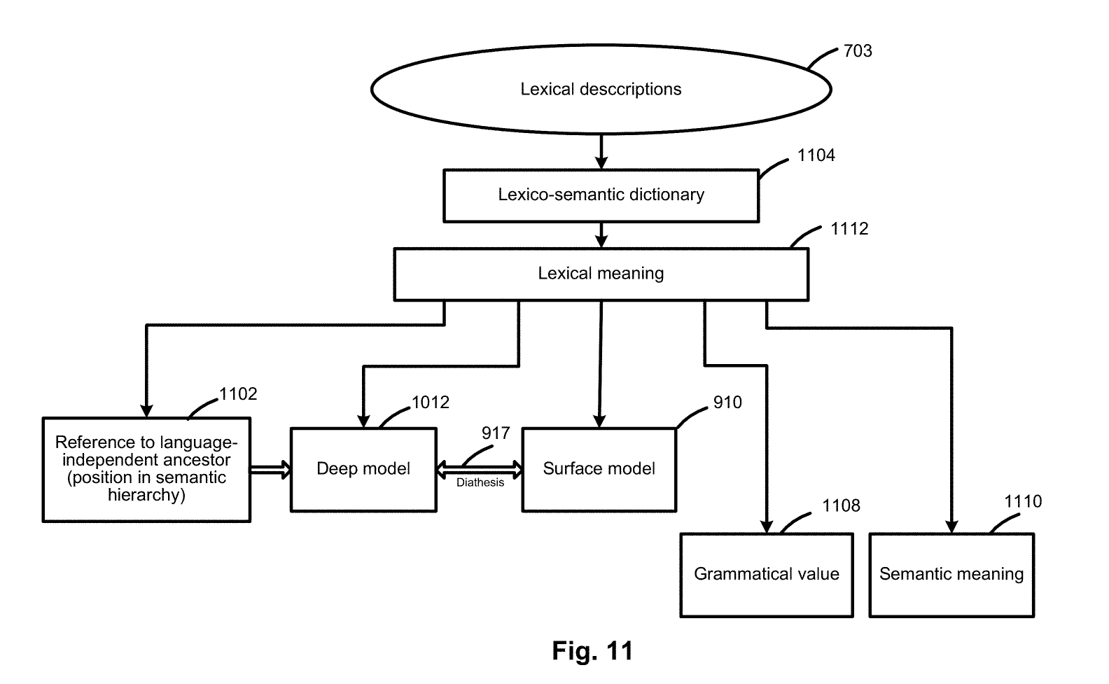

Furthermore, smart document generator 100 may perform natural language processing analysis of the natural language text 120 to determine one or more semantic, syntactic, or lexical relationships for the plurality of text regions 121. Natural language processing can include semantic search (including multi-lingual semantic search), document classification, etc. The natural language processing can analyze the meaning of the text in the natural language text 120 and identify the most meaningful word(s) in a sentence as well as whether or not adjacent sentences are related to each other in terms of subject matter. The natural language processing may be based on the use of a wide spectrum of linguistic descriptions. Examples of linguistic descriptions are described below with respect to FIG. 7. Semantic descriptions are described below with respect to FIG. 10. Syntactic descriptions are described below with respect to FIG. 9. Lexical descriptions are described below with respect to FIG. 11

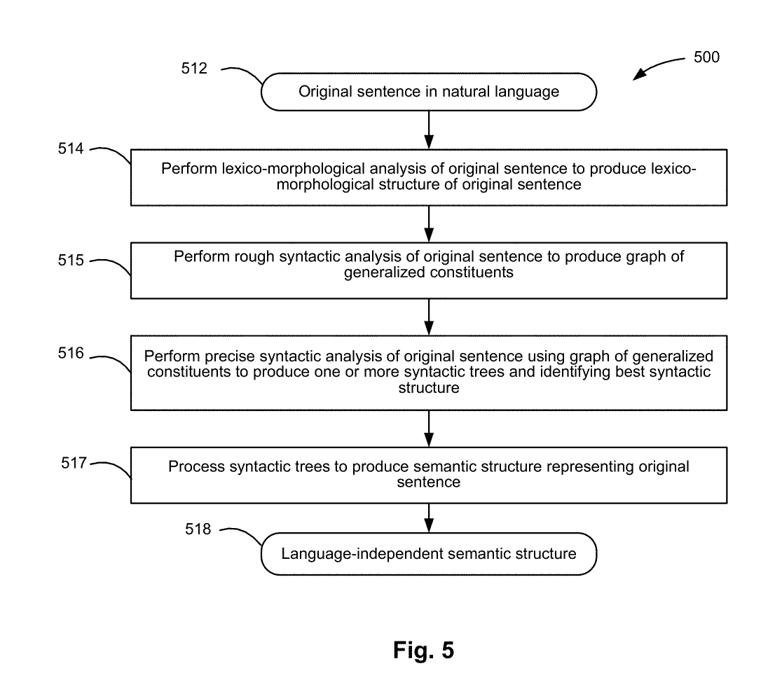

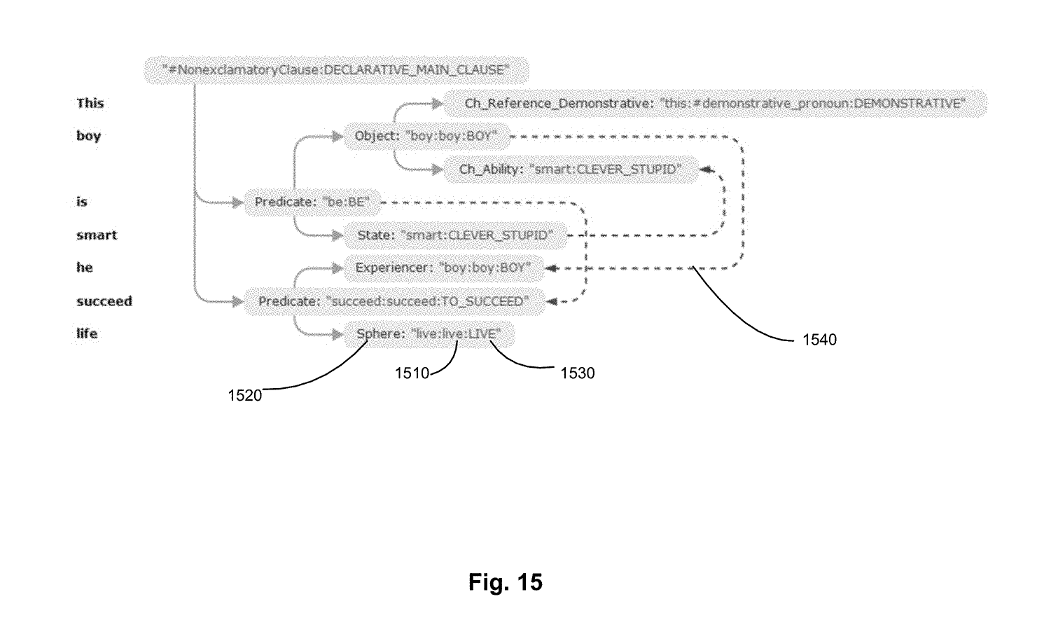

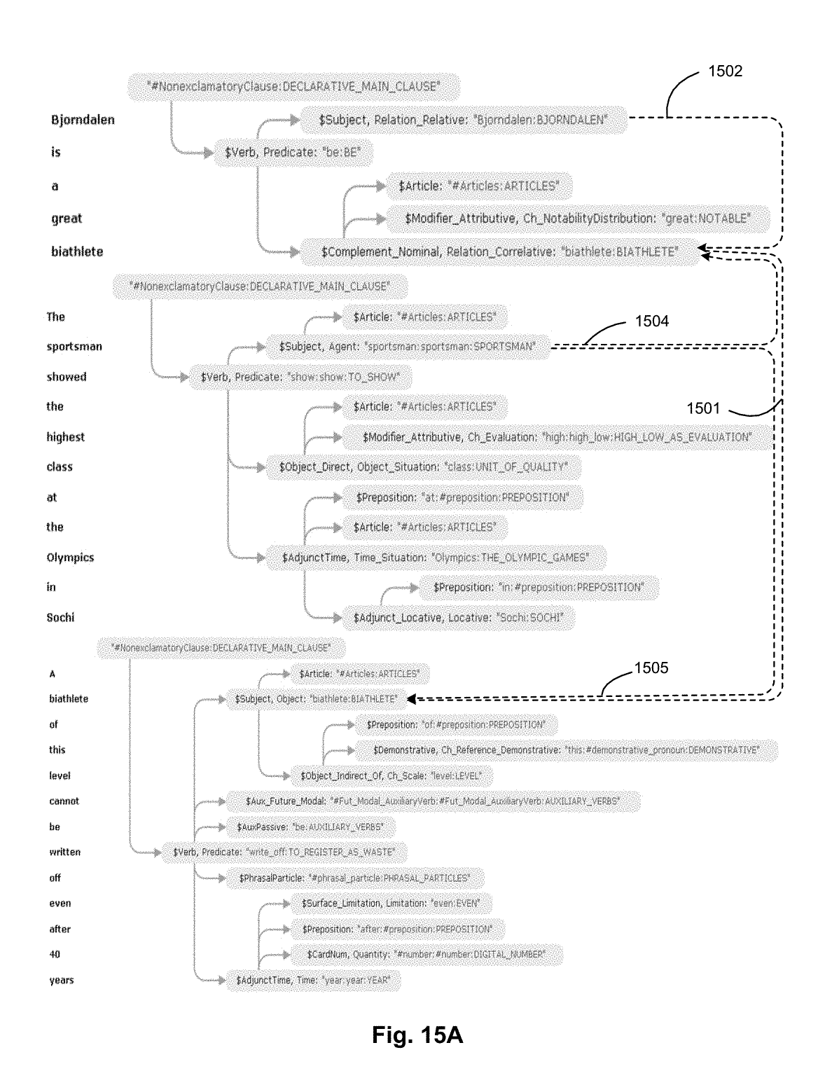

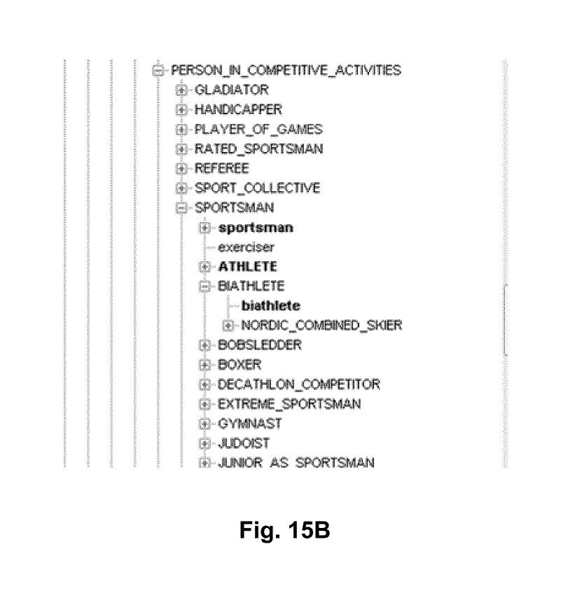

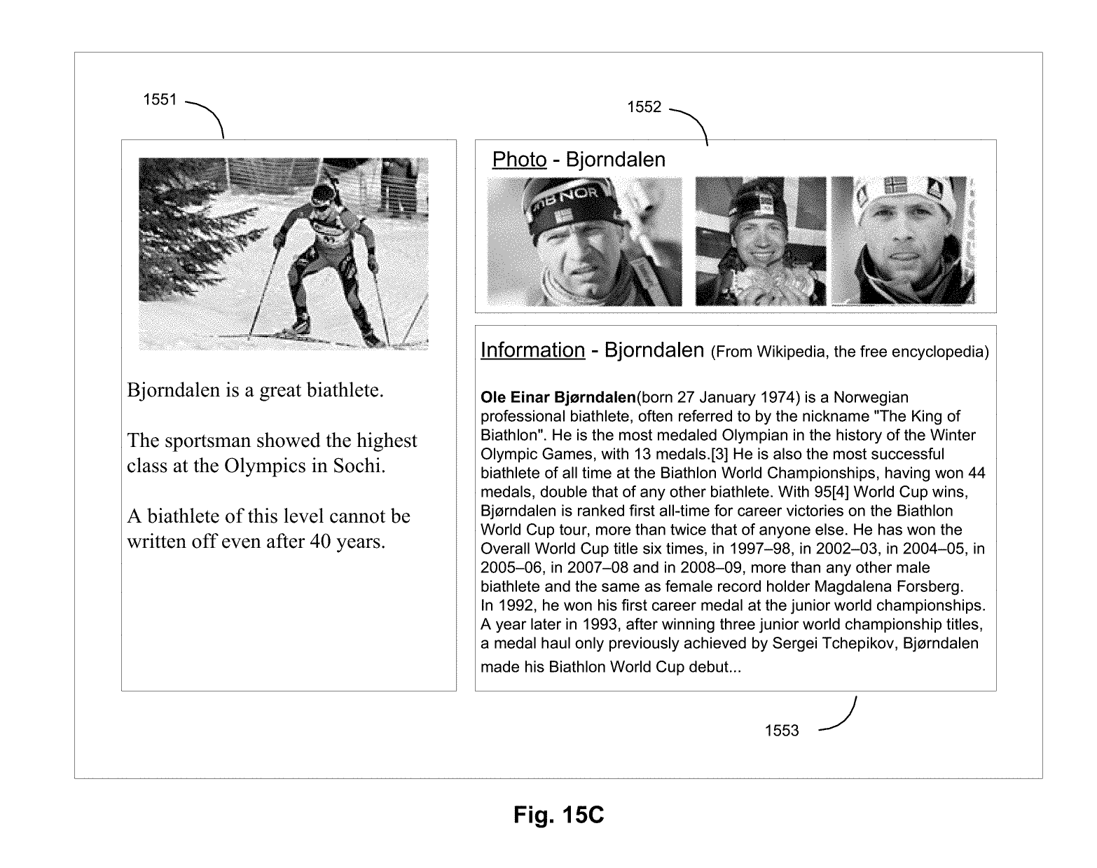

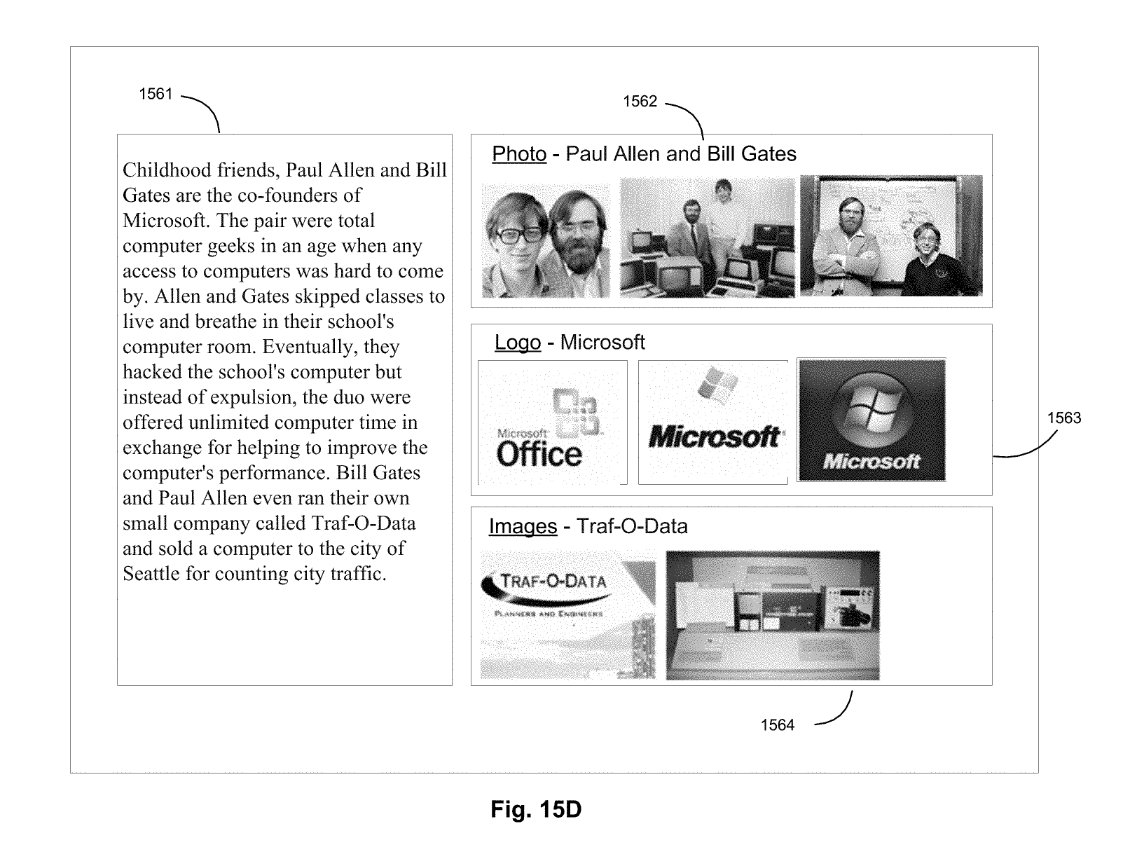

In some implementations, smart document generator 100 may perform the natural language processing by performing semantico-syntactic analysis of the natural language text 120 to produce a plurality of semantic structures, each of semantic structures is a semantic representation of a sentence of the natural language text 120. An example method of performing semantico-syntactic analysis is described blow with respect to FIG. 5. A semantic structure may be represented by an acyclic graph that includes a plurality of nodes corresponding to semantic classes and a plurality of edges corresponding to semantic relationships, as described in more details herein below with reference to FIG. 15.

Semantico-syntactic analysis can resolve ambiguities within text and obtain lexical, semantic, and syntactic features of a sentence as well as each word in the sentence, where the most important for the task is semantic classes. The semantico-syntactic analysis may also detect relationships within a sentence, as well as between sentences, such as anaphoric relations, coreferences, etc. as described in more detail below with respect to FIGS. 15A-C.

In some implementations, smart document generator 100 may perform the natural language processing by also performing information extraction including detecting named entities (e.g., persons, locations, organizations etc.) and facts related to the named entities. In some implementations, smart document generator 100 may perform the information extraction by additionally performing image analysis, metadata analysis, hashtag analysis, or the like.

Smart document generator 100 may then identify a first semantic structure for a first sentence of natural language text 120 and a second semantic structure for a second sentence of natural language text 120. Smart document generator 100 may further determine whether the first sentence is semantically related to the second sentence based on the semantic structures. Smart document generator 100 may make this determination by determining whether the second sentence has a referential or logical link with the first sentence based on the semantic structures of the sentences. In some implementations, smart document generator 100 may make the determination by detecting an anaphoric relation, detecting a coreference, by invoking a heuristic algorithm, or in any other manner. For example, if the second sentence comprises personal pronoun (it, he, she, they etc.) or demonstrative pronoun (this, these, such, that, those etc.) or similar words, then there is a high probability of a connection (e.g., a semantic relationship) existing between the second sentence and the first sentence.

In some implementations, smart document generator 100 may make the determination that the sentences are semantically related based on a semantic proximity metric. The semantic proximity metric may take into account various factors including, for example: existing referential or anaphoric links between elements of the two or more sentences, presence of the same named entities, presence of the same lexical or semantic classes associated with the nodes of the semantic structures, presence of parent-child relationships in certain nodes of the semantic structures, such that the parent and the child are divided by a certain number of semantic hierarchy levels; presence of a common ancestor for certain semantic classes and the distance between the nodes representing those classes, etc. If certain semantic classes are found equivalent or substantially similar, the metric may further take into account the presence or absence of certain differentiating semantemes and/or other factors.

Other factors may be also be taken into account. For example, if the second sentence begins with such words as thus, so; so then; well, then, now, etc. then the second sentence should be probably assigned to the next text region. In some implementations, two sentences may be considered semantically related if they contain the same named entities (persons, locations, organizations) within the limits of an allowable text region size.

Each of the factors used to determine the semantic relationship may contribute to an integrated value of the proximity metric. Thus, the value of semantic proximity metric may be calculated, and if it is greater than a threshold value, the two or more sentences may be considered as semantically related. In some implementations, smart document generator 100 may be preliminary trained with using machine learning methods. The machine learning may use not only lexical features, but also semantic and syntactic features produced in process of the semantico-syntactic analysis.

Responsive to determining that the first sentence is semantically related to the second sentence (e.g., the first sentence is related to the second sentence), smart document generator 100 may assign the first sentence and the second sentence to the same text region. For example, if smart document generator 100 determines that the two sentences are directed to similar subject matter, it may determine that the two sentences should appear on the same portion of the output document (e.g., the same slide of a presentation document). In some implementations, if the first text region already contains more than one sentence, but whose size less than an allowable text region size, smart document generator 100 can compare the sentences with other sentences in the text region to discover logical or semantic relations.

Responsive to determining that the second sentence is not semantically related to the first sentence, smart document generator 100 may assign the first sentence to a first text region and the second sentence to a second text region. For example, if smart document generator 100 determines that the two sentences are directed to different subject matters, it may determine that the two sentences should appear on different portions of the output document (e.g., different slides of a presentation document).

Subsequently, smart document generator 100 may automatically (without any user input or interaction) generate a search query to search for additional content related to the content of at least one of the text regions. The generated search query may be based at least in part on the most important words, semantic classes and/or named entities detected in the text regions, metadata, hashtags, etc. If the source text contains images, audio, video, or images, audio, video added by a user, their metadata and hashtags also may be used for creating a search query.

The search may include a full-text search or/and semantic search. For a semantic search the search query may include at least one of a property of one of the semantic structures for the text region, a semantic and/or syntactic 1 property of one of the sentences in the text region, one or more elements of the semantic classes of the text region, at least one named entity or any similar information produced by the natural language processing and information extraction. The most important words or semantic classes for the text region may be selected, for example, by means of a statistic, a heuristic, or in any other manner.

Various methods of information extraction, such as named entity recognition, may also be used to obtain the data for the search query. In one embodiment, an additional system component (e.g., InfoExtractor from Abbyy) may be employed to apply production rules to semantic structures, where the production rules are based on linguistic characteristics of the semantic structures and ontologies of subject matters for the sentences. The production rules may comprise at least interpretation rules and identification rules, where the interpretation rules specify fragments to be found in the semantic structures and include corresponding statements that form the set of logical conclusions in response to finding the fragments. The identification rules can be used to identify several references to the same information object in one or more sentences as well as the whole document.

In some implementations, smart document generator 100 may generate a separate search query for each of the identified text regions of the natural language text. The search query may be generated as a natural language sentence, a series of one or more separate words associated with the text region, a search query language (SQL) query, or in any other manner.

Smart document generator 100 may transmit the search query to one or more available information resources 160. Available information resources 160 can include a local data store of a computing device that executes smart document generator 100, a data store available via a local network, a resource available via the Internet (e.g., an Internet connected data store, a website, an online publication, a website, etc.), resources available via a social network platform, or the like.

In response to the submitted search query, smart document generator 100 may receive additional content items from information resources 160 that each relate to a respective text region of the natural language text. The additional content items can include an image, a chart, a quotation, a joke; logo, textual content from a reference data source (e.g., a dictionary entry, a wiki entry, etc.), or the like. In some implementations, smart document generator 100 may store the additional content items to a local data store so that they may be referenced in future searches. When storing the additional content items, smart document generator 100 may associate metadata with each additional content item to facilitate efficient retrieval on future requests. The metadata can include the information used in the search query so that future searches using similar information may result in retrieving the stored additional content items from the local data store prior to sending the search query to a network-based information resource.

In some implementations, where multiple additional content items are retrieved for a search query, smart document generator 100 may select one or more of the additional content items to be used when generating a combined document. In one embodiment, smart document generator 100 may make this selection based on input received from a user. Smart document generator 100 may automatically sort the received additional content items based on attributes associated with a user profile for the user to generate a sorted list. For example, if the user has established a preference for images over textual content, smart document generator 100 may sort the additional content items such that images appear first on the list. Similarly, if the user has established a preference for information from a particular information resource (e.g., information from an online publication data store), additional content items from that information resource may appear first on the list. Smart document generator 120 may then provide the list to the user (e.g., using a graphical user interface window displayed via a display of the computing device) and prompt the user for a selection of the additional content items to be associated with the text region. Smart document generator 120 may then generate a combined document using the user selection.

Alternatively, smart document generator 100 may make the selection automatically based on a stored priority profile. For example, a user may specify a preference for images over text content, so smart document generator 100 may select an image before considering any other type of content. Similarly, if the user has specified a preference for a particular information resource, additional content items from that resource may be selected before considering additional content from any other resource. Smart document generator 120 may then generate a combined document using the automatic selection.

Smart document generator 100 may then generate combined document 140 using the identified text regions 121 of the natural language text 120 combined with the additional content items received from information resources 160. Combined document 140 may include a plurality of document portions, each document portion including one of the text regions 121. Additionally, at least one of the document portions may include one or more of the additional content items that relate to the text region included in that document portion.

As shown in FIG. 1, smart document generator 100 may determine that natural language text 120 includes two text regions based on the sentences included in the text (e.g., the content may be logically divided into two portions). Smart document generator 100 may generate a query for each of the two regions and submit the query to information resources 160 as described above. Subsequently, smart document generator 100 may generate combined document 140 that includes two portions that each include one of the two text regions and the additional content item associated with that text region. Document portion 145-A includes text region 141-A and an additional content item 150-A (the additional content item associated with text region 141-A). Document portion 145-B includes text region 141-B and an additional content item 150-B (the additional content item associated with text region 141-B).

In some implementations, combined document 140 may be a presentation document (e.g., a Microsoft PowerPoint presentation, a PDF document, or the like). Each of the document portions 145-A, 145-B may represent a slide of the presentation where each slide includes a text region with a corresponding additional content item. Smart document generator 100 may format the text of text regions 141-A, 141-B based on a template layout for the presentation slide for document portions 145-A, 145-B. The template layout may be a document that includes a predefined structure and layout for the combined document. For example, the template layout may be a presentation document template that defines the style and/or layout of each slide in the presentation (e.g., the fonts used for each slide, the background color(s), the header and/or footer information on each slide, etc.). Similarly, the template layout may be a word processing document template that defines the style and/or layout of the document text. The text regions 141-A, 145-B may be formatted as lists, in bullet format, as paragraphs of text, or in any other manner.

In some implementations, combined document 140 may be an illustrated text document (e.g., an illustrated book). Each of the document portions 145-A, 145-B may represent a chapter of the book where each chapter includes the text for that chapter with a corresponding additional content item that illustrates the subject of that chapter.

Although for simplicity, FIG. 1 depicts a combined document that has only two portions, it should be noted that combined document 140 may include more than two document portions. Additionally, while combined document 140 depicts additional content items associated with both document portions 145-A and 145-B, in some cases combined document 140 may include one or more document portions 145-A, 145-B that may not include an associated additional content item, or it may include an additional content item that is associated with multiple document portions.

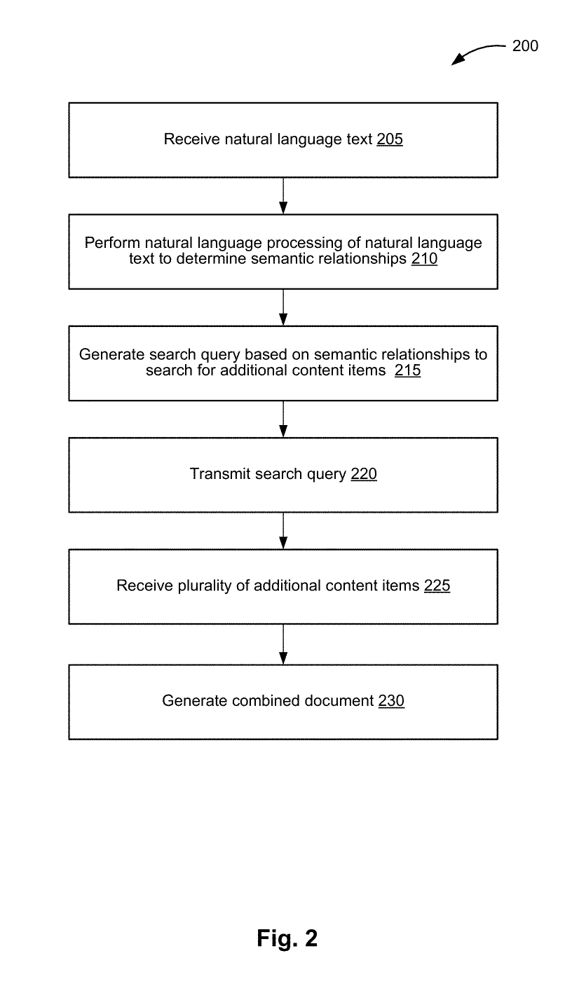

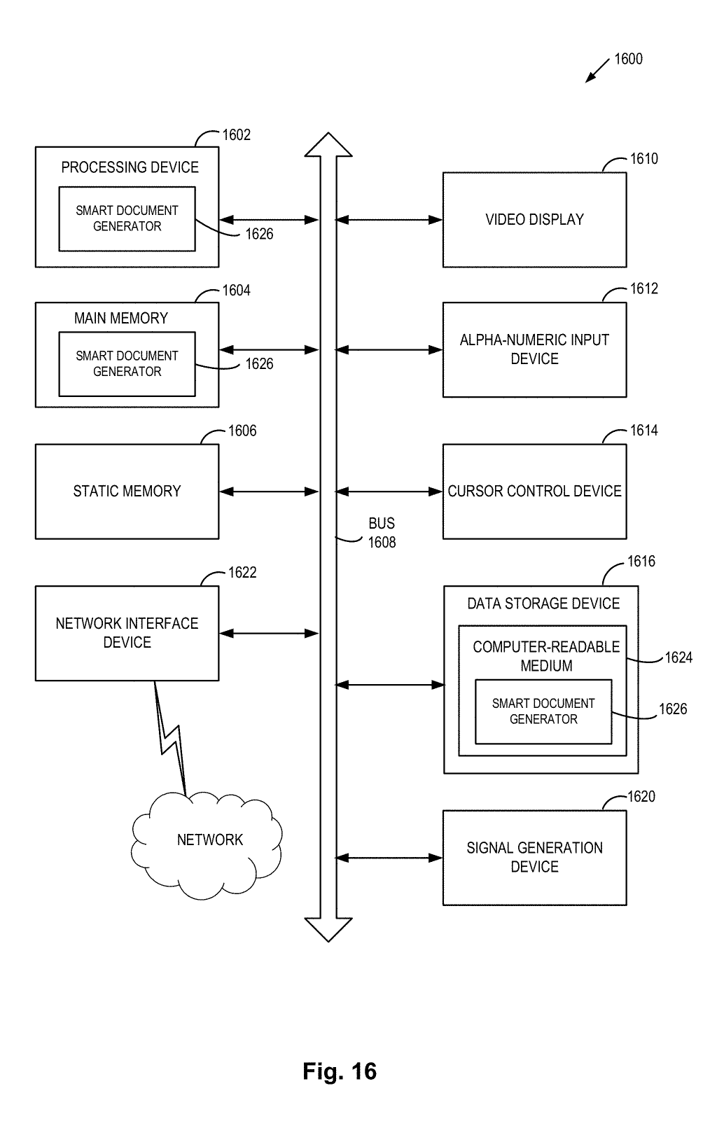

FIGS. 2-4 are flow diagrams of various implementations of methods related to generating combined documents based on natural language processing of natural language text. The methods are performed by processing logic that may include hardware (circuitry, dedicated logic, etc.), software (such as is run on a general purpose computer system or a dedicated machine), or a combination of both. The methods and/or each of their individual functions, routines, subroutines, or operations may be performed by one or more processors of a computing device (e.g., computing system 1600 of FIG. 16) implementing the methods. In certain implementations, the methods may be performed by a single processing thread. Alternatively, the methods may be performed by two or more processing threads, each thread implementing one or more individual functions, routines, subroutines, or operations of the methods. Some methods may be performed by a smart document generator such as smart document generator 100 of FIG. 1.

For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

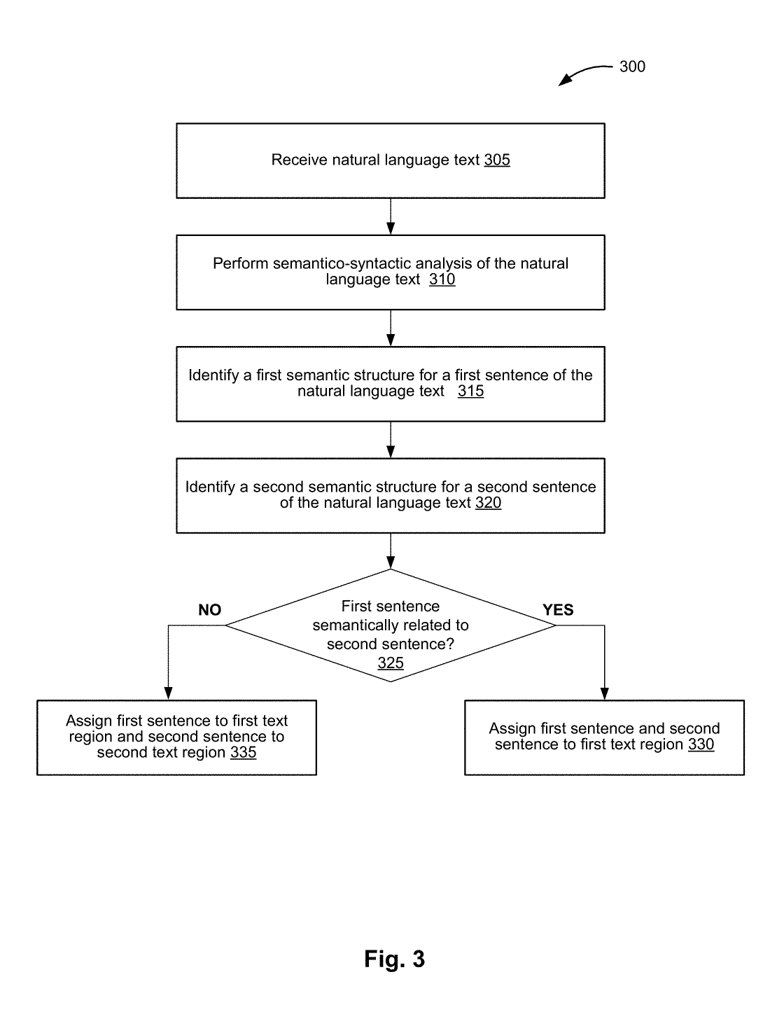

FIG. 2 depicts a flow diagram of an example method 200 for generating a combined document using natural language processing. At block 205 of method 200, processing logic receives a natural language text that comprises a plurality of text regions. At block 210, processing logic performs natural language processing of the natural language text received at block 205 to determine one or more logical and/or semantic relationships for the text regions of the natural language text. In an illustrative example, processing logic may perform the natural language processing as described below with respect to FIG. 3.

At block 215, processing logic generates a search query to search for additional content related to at least one text region of the plurality of text regions, where the search query is based on information about the text region produced on the previous step and the logical and/or semantic relationships for the at least one text regions. At block 220, processing logic transmits the search query to one or more available information resources. In some implementations, processing logic may submit a separate search query for each text region. Alternatively, processing logic may submit a single search query for all of the text regions. At block 225, processing logic receives a plurality of additional content items that each relate to a respective text region in response to the search query.

At block 230, processing logic generates a combined document comprising a plurality of portions, where each of the plurality of portions includes one of the plurality of text regions, and at least one of the plurality of portions further includes one or more of the plurality of additional content items received at block 225 that relate to a respective text region. After block 230, the method of FIG. 2 terminates.

FIG. 3 depicts a flow diagram of an example method 300 for performing natural language processing of a natural language text to determine semantic relationships. At block 305 of method 300, processing logic receives a natural language text that includes a plurality of text regions. At block 310, processing logic performs semantico-syntactic analysis of the natural language text to produce a plurality of semantic structures and links between them. In some implementations, each of the semantic structures represents a sentence of the natural language text. Referential links between some elements of different sentences may represent logical or semantic relationships between the sentences.

At block 315, processing logic identifies a first semantic structure for a first sentence of the natural language text. At block 320, processing logic identifies a second semantic structure for a second sentence of the natural language text. At block 325, processing logic determines whether the first sentence is semantically related to the second sentence. In some implementations, processing logic may make this determination by determining that first semantic structure is semantically related to second semantic structure based on a semantic proximity metric. If so, processing continues to block 330. Otherwise, processing proceeds to block 340. At block 330, processing logic assigns the first sentence and the second sentence to a single text region. After block 330, the method of FIG. 3 terminates

At block 335, processing logic assigns the first sentence to a first text region of the plurality of text regions and the second sentence to a second text region of the plurality of text regions. After block 335, the method of FIG. 3 terminates.

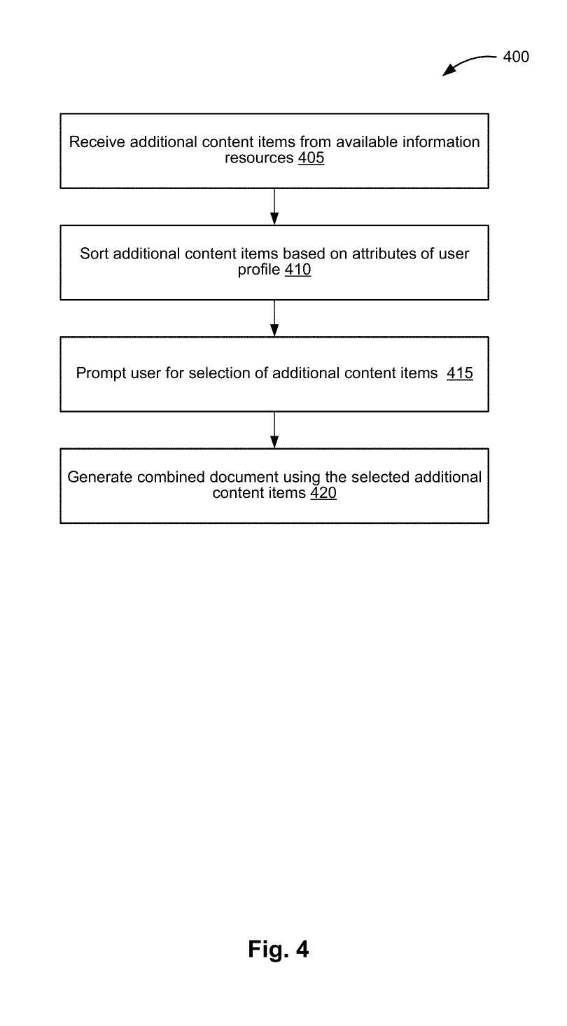

FIG. 4 depicts a flow diagram of an example method 400 for generating a combined document. At block 405 of method 400, processing logic receives additional content items from available information resources. At block 410, processing logic sorts the received additional content items based on attributes of a user profile. At block 415, processing logic prompts a user for a selection of one or more additional content items. At block 420, processing logic generates the combined document using the selected additional content items. After block 420, the method of FIG. 4 terminates.

FIG. 5 depicts a flow diagram of one illustrative example of a method 500 for performing a semantico-syntactic analysis of a natural language sentence 512, in accordance with one or more aspects of the present disclosure. Method 500 may be applied to one or more syntactic units (e.g., sentences), in order to produce a plurality of semantico-syntactic trees corresponding to the syntactic units. In various illustrative examples, the natural language sentences to be processed by method 500 may be retrieved from one or more electronic documents which may be produced by scanning or otherwise acquiring images of paper documents and performing optical character recognition (OCR) to produce the texts associated with the documents. The natural language sentences may be also retrieved from various other sources including electronic mail messages, social networks, digital content files processed by speech recognition methods, etc.

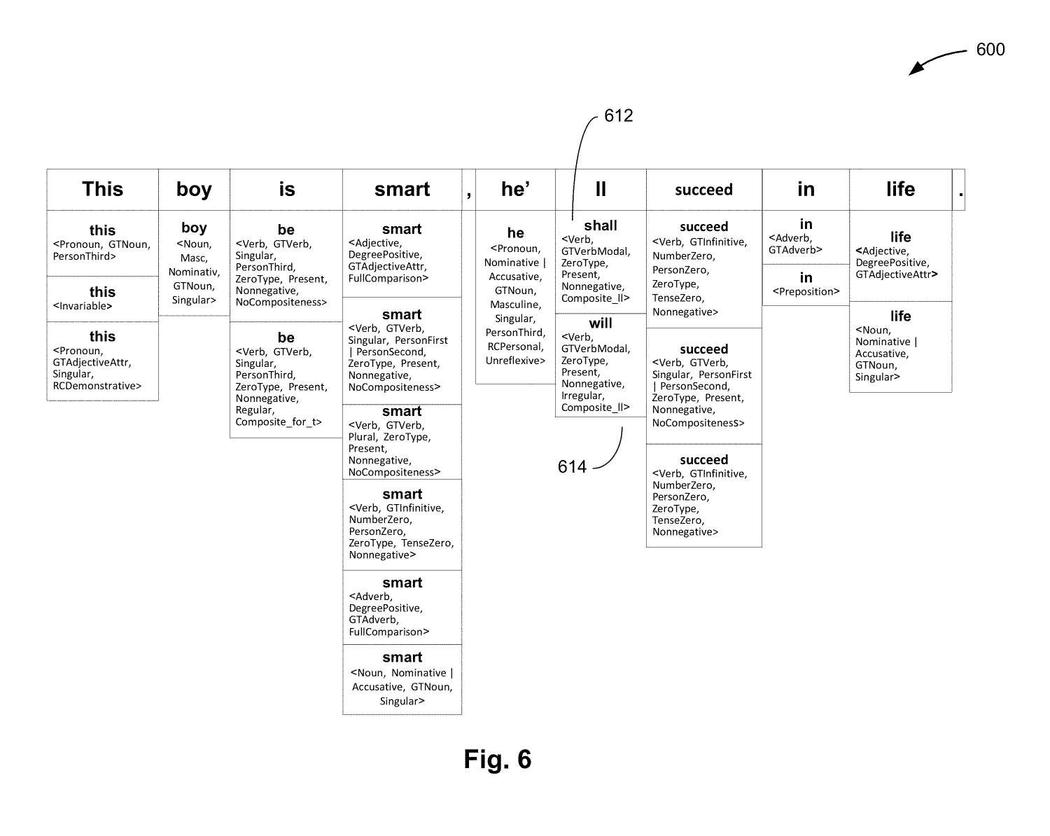

At block 514, the computing device implementing the method may perform lexico-morphological analysis of sentence 512 to identify morphological meanings of the words comprised by the sentence. “Morphological meaning” of a word herein shall refer to one or more lemma (i.e., canonical or dictionary forms) corresponding to the word and a corresponding set of values of grammatical attributes defining the grammatical value of the word. Such grammatical attributes may include the lexical category of the word and one or more morphological attributes (e.g., grammatical case, gender, number, conjugation type, etc.). Due to homonymy and/or coinciding grammatical forms corresponding to different lexico-morphological meanings of a certain word, two or more morphological meanings may be identified for a given word. An illustrative example of performing lexico-morphological analysis of a sentence is described in more details herein below with references to FIG. 6.

At block 515, the computing device may perform a rough syntactic analysis of sentence 512. The rough syntactic analysis may include identification of one or more syntactic models which may be associated with sentence 512 followed by identification of the surface (i.e., syntactic) associations within sentence 512, in order to produce a graph of generalized constituents. “Constituent” herein shall refer to a contiguous group of words of the original sentence, which behaves as a single grammatical entity. A constituent comprises a core represented by one or more words, and may further comprise one or more child constituents at lower levels. A child constituent is a dependent constituent and may be associated with one or more parent constituents.

At block 516, the computing device may perform a precise syntactic analysis of sentence 512, to produce one or more syntactic trees of the sentence. The pluralism of possible syntactic trees corresponding to a given original sentence may stem from homonymy and/or coinciding grammatical forms corresponding to different lexico-morphological meanings of one or more words within the original sentence. Among the multiple syntactic trees, one or more best syntactic tree corresponding to sentence 512 may be selected, based on a certain rating function talking into account compatibility of lexical meanings of the original sentence words, surface relationships, deep relationships, etc.

At block 517, the computing device may process the syntactic trees to the produce a semantic structure 518 corresponding to sentence 512. Semantic structure 518 may comprise a plurality of nodes corresponding to semantic classes, and may further comprise a plurality of edges corresponding to semantic relationships, as described in more details herein below.

FIG. 6 schematically illustrates an example of a lexico-morphological structure of a sentence, in accordance with one or more aspects of the present disclosure. Example lexical-morphological structure 600 may comprise having a plurality of “lexical meaning-grammatical value” pairs for an example sentence “This boy is smart, he'll succeed in life.” In an illustrative example, “ll” may be associated with lexical meaning “shall” 612 and “will” 614. The grammatical value associated with lexical meaning 512 is <Verb, GTVerbModal, ZeroType, Present, Nonnegative, Composite II>. The grammatical value associated with lexical meaning 614 is <Verb, GTVerbModal, ZeroType, Present, Nonnegative, Irregular, Composite II>.

FIG. 7 schematically illustrates language descriptions 710 representing a model of a natural language, in accordance with one or more aspects of the present disclosure. Language descriptions 710 include morphological descriptions 701, lexical descriptions 703, syntactic descriptions 702, and semantic descriptions 704, and their relationship thereof. Among them, morphological descriptions 701, lexical descriptions 703, and syntactic descriptions 702 are language-specific. A set of language descriptions 710 represent a model of a certain natural language.

In an illustrative example, a certain lexical meaning of lexical descriptions 703 may be associated with one or more surface models of syntactic descriptions 702 corresponding to this lexical meaning. A certain surface model of syntactic descriptions 702 may be associated with a deep model of semantic descriptions 704.

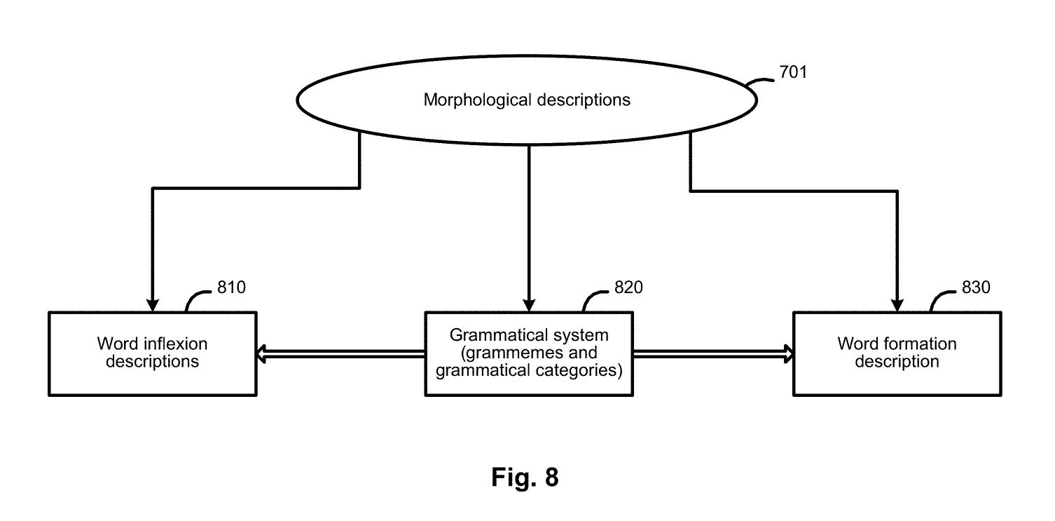

FIG. 8 schematically illustrates examples of morphological descriptions, in accordance with one or more aspects of the present disclosure. Components of the morphological descriptions 701 may include: word inflexion descriptions 810, grammatical system 820, and word formation description 830, among others. Grammatical system 820 comprises a set of grammatical categories, such as, part of speech, grammatical case, grammatical gender, grammatical number, grammatical person, grammatical reflexivity, grammatical tense, grammatical aspect, and their values (also referred to as “grammemes”), including, for example, adjective, noun, or verb; nominative, accusative, or genitive case; feminine, masculine, or neutral gender; etc. The respective grammemes may be utilized to produce word inflexion description 810 and the word formation description 830.

Word inflexion descriptions 810 describe the forms of a given word depending upon its grammatical categories (e.g., grammatical case, grammatical gender, grammatical number, grammatical tense, etc.), and broadly includes or describes various possible forms of the word. Word formation description 830 describes which new words may be constructed based on a given word (e.g., compound words).

According to one aspect of the present disclosure, syntactic relationships among the elements of the original sentence may be established using a constituent model. A constituent may comprise a group of neighboring words in a sentence that behaves as a single entity. A constituent has a word at its core and may comprise child constituents at lower levels. A child constituent is a dependent constituent and may be associated with other constituents (such as parent constituents) for building the syntactic structure of the original sentence.

FIG. 9 schematically illustrates examples of syntactic descriptions, in accordance with one or more aspects of the present disclosure.

The components of the syntactic descriptions 702 may include, but are not limited to, surface models 910, surface slot descriptions 920, referential and structural control description 956, control and agreement description 940, non-tree syntactic descriptions 950, and analysis rules 960. Syntactic descriptions 702 may be used to construct possible syntactic structures of the original sentence in a given natural language, taking into account free linear word order, non-tree syntactic phenomena (e.g., coordination, ellipsis, etc.), referential relationships, and other considerations.

Surface models 910 may be represented as aggregates of one or more syntactic forms (“syntforms” 912) employed to describe possible syntactic structures of the sentences that are comprised by syntactic description 702. In general, the lexical meaning of a natural language word may be linked to surface (syntactic) models 910. A surface model may represent constituents which are viable when the lexical meaning functions as the “core.” A surface model may include a set of surface slots of the child elements, a description of the linear order, and/or diatheses. “Diathesis” herein shall refer to a certain relationship between an actor (subject) and one or more objects, having their syntactic roles defined by morphological and/or syntactic means. In an illustrative example, a diathesis may be represented by a voice of a verb: when the subject is the agent of the action, the verb is in the active voice, and when the subject is the target of the action, the verb is in the passive voice.

A constituent model may utilize a plurality of surface slots 915 of the child constituents and their linear order descriptions 916 to describe grammatical values 914 of possible fillers of these surface slots. Diatheses 917 may represent relationships between surface slots 915 and deep slots 1014 (as shown in FIG. 10). Communicative descriptions 980 describe communicative order in a sentence.

Linear order description 916 may be represented by linear order expressions reflecting the sequence in which various surface slots 415 may appear in the sentence. The linear order expressions may include names of variables, names of surface slots, parenthesis, grammemes, ratings, the “or” operator, etc. In an illustrative example, a linear order description of a simple sentence of “Boys play football” may be represented as “Subject Core Object_Direct,” where Subject, Core, and Object_Direct are the names of surface slots 915 corresponding to the word order.

Communicative descriptions 980 may describe a word order in a syntform 912 from the point of view of communicative acts that are represented as communicative order expressions, which are similar to linear order expressions. The control and agreement description 440 may comprise rules and restrictions which are associated with grammatical values of the related constituents and may be used in performing syntactic analysis.

Non-tree syntax descriptions 950 may be created to reflect various linguistic phenomena, such as ellipsis and coordination, and may be used in syntactic structures transformations which are generated at various stages of the analysis according to one or more aspects of the present disclosure. Non-tree syntax descriptions 950 may include ellipsis description 952, coordination description 954, as well as referential and structural control description 930, among others.

Analysis rules 960 may generally describe properties of a specific language and may be used in performing the semantic analysis. Analysis rules 960 may comprise rules of identifying semantemes 962 and normalization rules 964. Normalization rules 964 may be used for describing language-dependent transformations of semantic structures.

FIG. 10 schematically illustrates examples of semantic descriptions, in accordance with one or more aspects of the present disclosure. Components of semantic descriptions 704 are language-independent and may include, but are not limited to, a semantic hierarchy 1010, deep slots descriptions 1020, a set of semantemes 1030, and pragmatic descriptions 1040.

The core of the semantic descriptions is represented by semantic hierarchy 1010 which may comprise semantic notions (semantic entities) which are also referred to as semantic classes. The latter may be arranged into hierarchical structure reflecting parent-child relationships. In general, a child semantic class may inherits one or more properties of its direct parent and other ancestor semantic classes. In an illustrative example, semantic class SUBSTANCE is a child of semantic class ENTITY and the parent of semantic classes GAS, LIQUID, METAL, WOOD_MATERIAL, etc.

Each semantic class in semantic hierarchy 1010 may be associated with a corresponding deep model 1012. Deep model 1012 of a semantic class may comprise a plurality of deep slots 1014 which may reflect semantic roles of child constituents in various sentences that include objects of the semantic class as the core of the parent constituent. Deep model 1012 may further comprise possible semantic classes acting as fillers of the deep slots. Deep slots 1014 may express semantic relationships, including, for example, “agent,” “addressee,” “instrument,” “quantity,” etc. A child semantic class may inherit and further expand the deep model of its direct parent semantic class.

Deep slots descriptions 1020 reflect semantic roles of child constituents in deep models 1012 and may be used to describe general properties of deep slots 1014. Deep slots descriptions 520 may also comprise grammatical and semantic restrictions associated with the fillers of deep slots 1014. Properties and restrictions associated with deep slots 1014 and their possible fillers in various languages may be substantially similar and often identical. Thus, deep slots 1014 are language-independent.

System of semantemes 1030 may represents a plurality of semantic categories and semantemes which represent meanings of the semantic categories. In an illustrative example, a semantic category “DegreeOfComparison” may be used to describe the degree of comparison and may comprise the following semantemes: “Positive,” “ComparativeHigherDegree,” and “SuperlativeHighestDegree,” among others. In another illustrative example, a semantic category “RelationToReferencePoint” may be used to describe an order (spatial or temporal in a broad sense of the words being analyzed), such as before or after a reference point, and may comprise the semantemes “Previous” and “Subsequent.”. In yet another illustrative example, a semantic category “EvaluationObjective” can be used to describe an objective assessment, such as “Bad,” “Good,” etc.

System of semantemes 1030 may include language-independent semantic attributes which may express not only semantic properties but also stylistic, pragmatic and communicative properties. Certain semantemes may be used to express an atomic meaning which corresponds to a regular grammatical and/or lexical expression in a natural language. By their intended purpose and usage, sets of semantemes may be categorized, e.g., as grammatical semantemes 1032, lexical semantemes 1034, and classifying grammatical (differentiating) semantemes 1036.

Grammatical semantemes 1032 may be used to describe grammatical properties of the constituents when transforming a syntactic tree into a semantic structure. Lexical semantemes 1034 may describe specific properties of objects (e.g., “being flat” or “being liquid”) and may be used in deep slot descriptions 520 as restriction associated with the deep slot fillers (e.g., for the verbs “face (with)” and “flood,” respectively). Classifying grammatical (differentiating) semantemes 1036 may express the differentiating properties of objects within a single semantic class. In an illustrative example, in the semantic class of HAIRDRESSER, the semanteme of <<RelatedToMen>> is associated with the lexical meaning of “barber,” to differentiate from other lexical meanings which also belong to this class, such as “hairdresser,” “hairstylist,” etc. Using these language-independent semantic properties that may be expressed by elements of semantic description, including semantic classes, deep slots, and semantemes, may be employed for extracting the semantic information, in accordance with one or more aspects of the present invention.

Pragmatic descriptions 1040 allow associating a certain theme, style or genre to texts and objects of semantic hierarchy 1010 (e.g., “Economic Policy,” “Foreign Policy,” “Justice,” “Legislation,” “Trade,” “Finance,” etc.). Pragmatic properties may also be expressed by semantemes. In an illustrative example, the pragmatic context may be taken into consideration during the semantic analysis phase.

FIG. 11 schematically illustrates examples of lexical descriptions, in accordance with one or more aspects of the present disclosure. Lexical descriptions 703 represent a plurality of lexical meanings 1112, in a certain natural language, for each component of a sentence. For a lexical meaning 1112, a relationship 1102 to its language-independent semantic parent may be established to indicate the location of a given lexical meaning in semantic hierarchy 1010.

A lexical meaning 1112 of lexical-semantic hierarchy 1010 may be associated with a surface model 910 which, in turn, may be associated, by one or more diatheses 917, with a corresponding deep model 1012. A lexical meaning 1112 may inherit the semantic class of its parent, and may further specify its deep model 1012.

A surface model 910 of a lexical meaning may comprise includes one or more syntforms 912. A syntform, 912 of a surface model 910 may comprise one or more surface slots 915, including their respective linear order descriptions 916, one or more grammatical values 914 expressed as a set of grammatical categories (grammemes), one or more semantic restrictions associated with surface slot fillers, and one or more of the diatheses 917. Semantic restrictions associated with a certain surface slot filler may be represented by one or more semantic classes, whose objects can fill the surface slot.

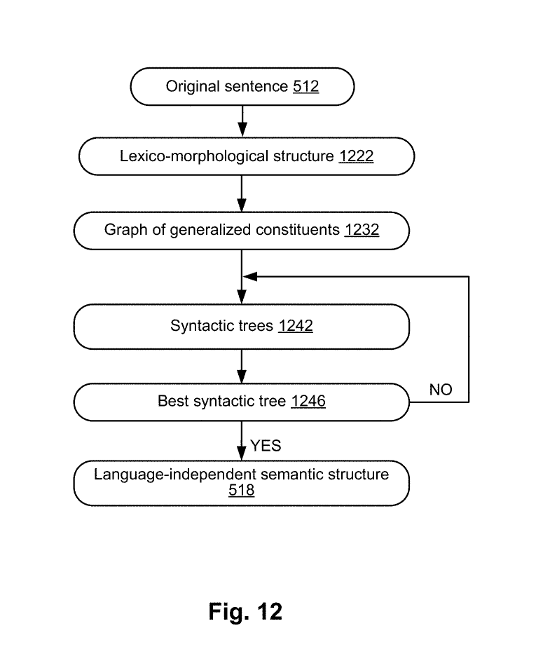

FIG. 12 schematically illustrates example data structures that may be employed by one or more methods implemented in accordance with one or more aspects of the present disclosure. Referring again to FIG. 5, at block 514, the computing device implementing the method may perform lexico-morphological analysis of sentence 512 to produce a lexico-morphological structure 1222 of FIG. 12. Lexico-morphological structure 1222 may comprise a plurality of mapping of a lexical meaning to a grammatical value for each lexical unit (e.g., word) of the original sentence. FIG. 6 schematically illustrates an example of a lexico-morphological structure.

At block 515, the computing device may perform a rough syntactic analysis of original sentence 512, in order to produce a graph of generalized constituents 1232 of FIG. 12. Rough syntactic analysis involves applying one or more possible syntactic models of possible lexical meanings to each element of a plurality of elements of the lexico-morphological structure 1222, in order to identify a plurality of potential syntactic relationships within original sentence 512, which are represented by graph of generalized constituents 1232.

Graph of generalized constituents 1232 may be represented by an acyclic graph comprising a plurality of nodes corresponding to the generalized constituents of original sentence 512, and further comprising a plurality of edges corresponding to the surface (syntactic) slots, which may express various types of relationship among the generalized lexical meanings. The method may apply a plurality of potentially viable syntactic models for each element of a plurality of elements of the lexico-morphological structure of original sentence 512 in order to produce a set of core constituents of original sentence 512. Then, the method may consider a plurality of viable syntactic models and syntactic structures of original sentence 512 in order to produce graph of generalized constituents 1232 based on a set of constituents. Graph of generalized constituents 1232 at the level of the surface model may reflect a plurality of viable relationships among the words of original sentence 512. As the number of viable syntactic structures may be relatively large, graph of generalized constituents 1232 may generally comprise redundant information, including relatively large numbers of lexical meaning for certain nodes and/or surface slots for certain edges of the graph.

Graph of generalized constituents 1232 may be initially built as a tree, starting with the terminal nodes (leaves) and moving towards the root, by adding child components to fill surface slots 915 of a plurality of parent constituents in order to reflect all lexical units of original sentence 512.

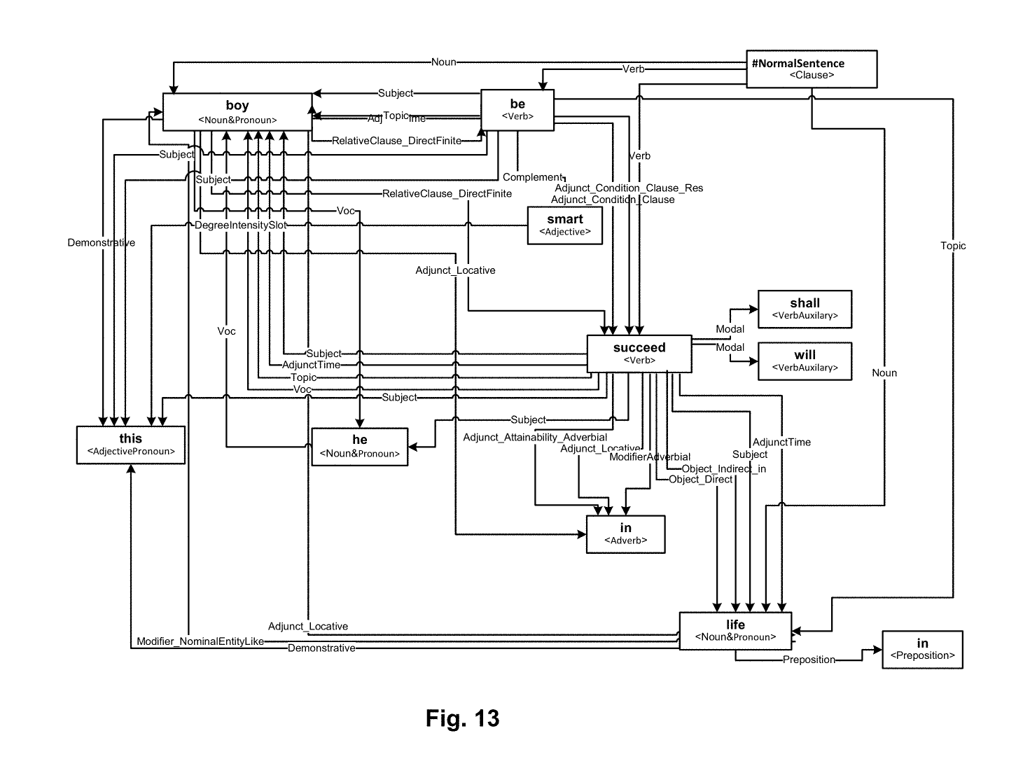

In certain implementations, the root of graph of generalized constituents 1232 represents a predicate. In the course of the above described process, the tree may become a graph, as certain constituents of a lower level may be included into one or more constituents of an upper level. A plurality of constituents that represent certain elements of the lexico-morphological structure may then be generalized to produce generalized constituents. The constituents may be generalized based on their lexical meanings or grammatical values 914, e.g., based on part of speech designations and their relationships. FIG. 13 schematically illustrates an example graph of generalized constituents.

At block 516, the computing device may perform a precise syntactic analysis of sentence 512, to produce one or more syntactic trees 1242 of FIG. 12 based on graph of generalized constituents 1232. For each of one or more syntactic trees, the computing device may determine a general rating based on certain calculations and a priori estimates. The tree having the optimal rating may be selected for producing the best syntactic structure 1246 of original sentence 512.

In the course of producing the syntactic structure 1246 based on the selected syntactic tree, the computing device may establish one or more non-tree links (e.g., by producing redundant path among at least two nodes of the graph). If that process fails, the computing device may select a syntactic tree having a suboptimal rating closest to the optimal rating, and may attempt to establish one or more non-tree relationships within that tree. Finally, the precise syntactic analysis produces a syntactic structure 1246 which represents the best syntactic structure corresponding to original sentence 512. In fact, selecting the best syntactic structure 1246 also produces the best lexical values of original sentence 512.

At block 517, the computing device may process the syntactic trees to the produce a semantic structure 518 corresponding to sentence 512. Semantic structure 518 may reflect, in language-independent terms, the semantics conveyed by original sentence 512. Semantic structure 518 may be represented by an acyclic graph (e.g., a tree complemented by at least one non-tree link, such as an edge producing a redundant path among at least two nodes of the graph). The original natural language words are represented by the nodes corresponding to language-independent semantic classes of semantic hierarchy 1010. The edges of the graph represent deep (semantic) relationships between the nodes. Semantic structure 518 may be produced based on analysis rules 960, and may involve associating, one or more attributes (reflecting lexical, syntactic, and/or semantic properties of the words of original sentence 512) with each semantic class.

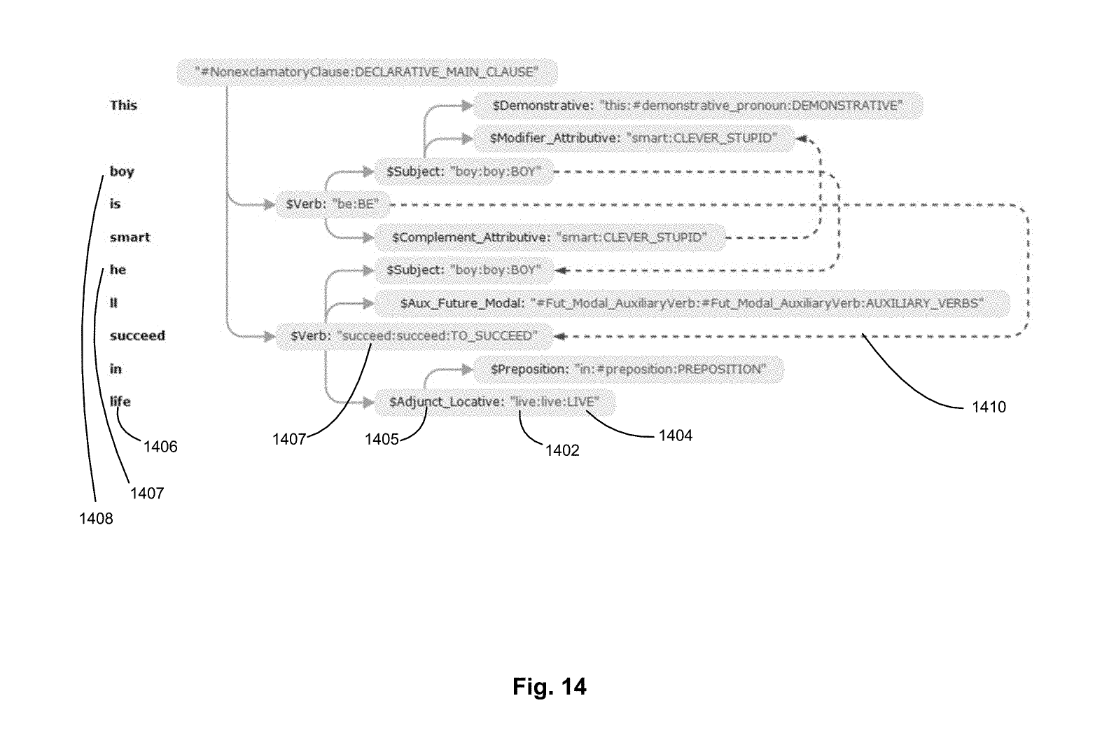

FIG. 14 illustrates an example syntactic structure corresponding to the sentence “This boy is smart, he'll succeed in life.” illustrated by FIG. 6 and FIG. 13. By applying the method of syntactico-semantic analysis described herein, the computing device may establish that lexical element “life” 1406 represents one of the lexemes of a derivative form “live” 1402 associated with a semantic class “LIVE” 1404, and fills in a surface slot $Adjunctr_Locative (1405) of the parent constituent, which is represented by a controlling node $Verb:succeed:succeed:TO_SUCCEED (1407). Additionally, this sentence is a compound sentence, and it contains anaphoric link 1410 which correlates “he” 1407 with “boy” 1408.

FIG. 15 illustrates a semantic structure corresponding to the syntactic structure of FIG. 14. With respect to the above referenced lexical element “life” 1406 of FIG. 14, the semantic structure comprises lexical class 1510 and semantic classes 1530 similar to those of FIG. 14, but instead of surface slot 1405, the semantic structure comprises a deep slot “Sphere” 1520. The anaphoric link 1410 is shown in semantic structure as 1540.

FIG. 15A illustrates an example of establishing relations between a set of sentences. In addition to the use of rules based on syntactic models, semantic restrictions can be taken into account. For example, if a certain node of the syntactic-semantic structure with a subordinate node representing a “person” as the object has a nominal complement, the system establishes a special supplemental link from the object to this complement. Then, if this same lexeme is encountered anywhere else in the text as complement, the second “person” will be identified and merged with the first by this special link (two person objects will merge due to that special link). For example, there is the problem of identifying the entities Bjorndalen=biathlete=sportsman in the following example: Bjorndalen is a great biathlete. The sportsman showed the highest class at the Olympics in Sochi. A biathlete of this level cannot be written off even after 40 years.

FIG. 15A illustrates the example of these semantic structures with the supplemental referential relationships. First of all, the extraction rules identify three entities: “Bjorndalen”, “biathlete”, and a second “biathlete”. The two “biathlete” mentions are merged into a single entity (relation 1501) on the basis of belonging to the same semantic class and after the syntactic structure of the first sentence indicates an identification of the first “biathlete” occurrence with the surname Bjorndalen (relation 1502). In order to reconstruct the entire co-reference chain, the link between “biathlete/Bjorndalen” to “sportsman” (links 1504 and 1505) should be established.

In one possible aspect, grammatical attributes (gender, number, animacy, and so on) can be used for the filtering of the pairs, and the metric of semantic closeness in the aforementioned semantic hierarchy is also used. In this case, the “distance” between the lexical meanings can be estimated. FIG. 15B shows a fragment of the semantic hierarchy with the lexical meanings “biathlete” and “sportsman”. These are found in the same “branch” of the tree of the semantic hierarchy and “biathlete” is found in the singled-out semantic class BIATHLETE, which in turn is a direct descendant of the semantic class SPORTSMAN, while “sportsman” is directly included in this same class SPORTSMAN. That is, “biathlete” and “sportsman” are situated “close” in the semantic hierarchy, they have a common “ancestor”—the semantic class SPORTSMAN, and moreover “sportsman” is its representative member and in this sense a hyperonym in regard to “biathlete”. Speaking informally, to move from “biathlete” to “sportsman” in the semantic hierarchy no more than a few steps should be made. The metric can take account of the affiliation with the same semantic class, the presence of a closely located common ancestor—the semantic class, the representativeness, the presence/absence of certain semantemes, and so on.

FIG. 15C depicts an example of an illustrated fragment of the text for the sentences of FIG. 15A, in accordance with one or more aspects of the present disclosure. The smart document generator described above can analyze the semantic relationships between the sentences of 1551, and generate queries to search for related information as described herein. As shown in FIG. 15C, by analyzing sentences 1551, additional photographs 1552 of Bjorndalen as well as wiki document information 1553 may be obtained and added to an illustrated fragment (e.g., page, presentation slide, etc.) of the resulting combined document.

FIG. 15D depicts another example of an illustrated fragment of text, in accordance with one or more aspects of the present disclosure. The smart document generator described above can analyze the semantic relationships between the sentences of 1561, and generate queries to search for related information as described herein. As shown in FIG. 15D, by analyzing sentences 1561, additional photographs 1562 of the subjects of the sentences 1561 (e.g., Paul Allen and Bill Gates) as well as image information 1563 (e.g., Microsoft logo since ‘Microsoft’ is mentioned in one of sentences 1561), and image information 1564 (e.g., Traf-O-Data information since ‘Traf-O-Data’ is mentioned in one of sentences 1561) may be obtained and added to an illustrated fragment (e.g., page, presentation slide, etc.) of the resulting combined document.

FIG. 16 depicts an example computer system 1600 which can perform any one or more of the methods described herein. In one example, computer system 1600 may correspond to a computing device capable of executing smart document generator 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 1600 includes a processing device 1602, a main memory 1604 (e.g., read-only memory (ROM), flash memory, dynamic random access memory (DRAM) such as synchronous DRAM (SDRAM)), a static memory 1606 (e.g., flash memory, static random access memory (SRAM)), and a data storage device 1616, which communicate with each other via a bus 1608.

Processing device 1602 represents one or more general-purpose processing devices such as a microprocessor, central processing unit, or the like. More particularly, the processing device 1602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 may also be one or more special-purpose processing devices such as an application specific integrated circuit (ASIC), a field programmable gate array (FPGA), a digital signal processor (DSP), network processor, or the like. The processing device 1602 is configured to execute smart document generator module 1626 for performing the operations and steps discussed herein.

The computer system 1600 may further include a network interface device 1622. The computer system 1600 also may include a video display unit 1610 (e.g., a liquid crystal display (LCD) or a cathode ray tube (CRT)), an alphanumeric input device 1612 (e.g., a keyboard), a cursor control device 1614 (e.g., a mouse), and a signal generation device 1620 (e.g., a speaker). In one illustrative example, the video display unit 1610, the alphanumeric input device 1612, and the cursor control device 1614 may be combined into a single component or device (e.g., an LCD touch screen).

The data storage device 1616 may include a computer-readable medium 1624 on which is stored smart document generator 1626 (e.g., corresponding to the methods of FIGS. 2-4, etc.) embodying any one or more of the methodologies or functions described herein. Smart document generator 1626 may also reside, completely or at least partially, within the main memory 1604 and/or within the processing device 1602 during execution thereof by the computer system 1600, the main memory 1604 and the processing device 1602 also constituting computer-readable media. Smart document generator 1626 may further be transmitted or received over a network via the network interface device 1622.

While the computer-readable storage medium 1624 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “performing,” “generating,” “transmitting,” “identifying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
receiving, by a processing device, a natural language text that comprises a plurality of text regions;
performing, by the processing device, natural language processing of the natural language text to determine one or more semantic relationships within the plurality of text regions;
generating, by the processing device, a search query to search for additional content related to at least one text region of the plurality of text regions, wherein the search query is based on results of the natural language processing for the at least one text regions;
transmitting the search query to one or more available information resources;
receiving a plurality of additional content items that each relate to a respective text region of the plurality of text regions in response to the search query; and
generating, by the processing device, a combined document comprising a plurality of portions, wherein each portion comprises one of the plurality of text regions, and at least one of the plurality of portions further comprising one or more of the plurality of additional content items that relate to a respective text region.

2. The method of claim 1, wherein performing natural language processing analysis of the natural language text further comprises:
performing semantico-syntactic analysis of the natural language text to produce a plurality of semantic structures, each semantic structure of the plurality of semantic structures representing a sentence of the natural language text;
identifying a first semantic structure of the plurality of semantic structures for a first sentence of the natural language text and a second semantic structure of the plurality of semantic structures for a second sentence of the natural language text; and
determining whether the first semantic structure for the first sentence is semantically related to the second semantic structure for the second sentence based on a semantic proximity metric value.

3. The method of claim 2, further comprising:
performing an information extraction operation comprising at least one of named entity recognition, image analysis, metadata analysis, or hashtag analysis.

4. The method of claim 2, further comprising:
responsive to determining that the semantic proximity metric value is greater than or equal to a threshold value, assigning the first sentence and the second sentence to a first text region of the plurality of text regions.

5. The method of claim 2, further comprising:
responsive to determining that the semantic proximity metric value is less than the threshold value, assigning the first sentence to a first text region of the plurality of text regions and the second sentence to a second text region of the plurality of text regions.

6. The method of claim 2, wherein the search query comprises at least one of a property of one of the sentences in the text region, a semantic class, a lexical class, a named entity metadata, or a hashtag.

7. The method of claim 1, wherein the one or more available information resources comprises at least one of a local data store, a data store available via a local network, resource available via the Internet, or resources available via social network.

8. The method of claim 1, wherein the one or more additional content items comprises at least one of an image, a chart, a logo, a quotation, a joke, a video, an audio file, or textual content from a reference data source.

9. The method of claim 1, further comprising:
ranking the additional content items based on attributes associated with a user profile to generate a sorted list;
prompting a user for a selection of one or more of the additional content items from the sorted list; and
generating the combined document using the selection.

10. The method of claim 1, further comprising:
selecting one or more of the additional content items based on a priority profile; and
generating the combined document using the selection.

11. The method of claim 1, wherein the combined document comprises a presentation document, and each of the plurality of portions comprises a slide of the presentation document.

12. A computing apparatus comprising:
a memory to store instructions; and
a processing device, operatively coupled to the memory, to execute the instructions, wherein the processing device is to:
receive, by the processing device, a natural language text that comprises a plurality of text regions;
perform, by the processing device, natural language processing of the natural language text to determine one or more semantic relationships within the plurality of text regions;
generate, by the processing device, a search query to search for additional content related to at least one text region of the plurality of text regions, wherein the search query is based on results of the natural language processing for the at least one text regions;
transmit the search query to one or more available information resources;
receive a plurality of additional content items that each relate to a respective text region of the plurality of text regions in response to the search query; and
generate, by the processing device, a combined document comprising a plurality of portions, wherein each portion comprises one of the plurality of text regions, and at least one of the plurality of portions further comprising one or more of the plurality of additional content items that relate to a respective text region.

13. The computing apparatus of claim 12, wherein to perform the natural language processing analysis of the natural language text, the processing device is to:
perform semantico-syntactic analysis of the natural language text to produce a plurality of semantic structures, each semantic structure of the plurality of semantic structures representing a sentence of the natural language text;
identify a first semantic structure of the plurality of semantic structures for a first sentence of the natural language text and a second semantic structure of the plurality of semantic structures for a second sentence of the natural language text; and
determine whether the first semantic structure for the first sentence is semantically related to the second semantic structure for the second sentence based on a semantic proximity metric value.

14. The computing apparatus of claim 13, wherein the processing device is further to:
perform an information extraction operation comprising at least one of named entity recognition, image analysis, metadata analysis, or hashtag analysis.

15. The computing apparatus of claim 13, wherein the processing device is further to:
responsive to determining that the semantic proximity metric value is greater than or equal to a threshold value, assign the first sentence and the second sentence to a first text region of the plurality of text regions.

16. The computing apparatus of claim 13, wherein the processing device is further to:
responsive to determining that the semantic proximity metric value is less than the threshold value, assign the first sentence to a first text region of the plurality of text regions and the second sentence to a second text region of the plurality of text regions

17. The computing apparatus of claim 13, wherein the search query comprises at least one of a property of one of the sentences in the text region, a semantic class, a lexical class, a named entity, metadata, or a hashtag.

18. The computing apparatus of claim 12, wherein the one or more available information resources comprises at least one of a local data store, a data store available via a local network, resource available via the Internet, or resources available via social network.

19. The computing apparatus of claim 12, wherein the one or more additional content items comprises at least one of an image, a chart, a logo, a quotation, a joke, a video, an audio file, or textual content from a reference data source.

20. The computing apparatus of claim 12, wherein the processing device is further to:
rank the additional content items based on attributes associated with a user profile to generate a sorted list;
prompt a user for a selection of one or more of the additional content items from the sorted list; and
generate the combined document using the selection.

21. The computing apparatus of claim 12, wherein the processing device is further to:
select one or more of the additional content items based on a priority profile; and
generate the combined document using the selection.

22. The computing apparatus of claim 12, wherein the combined document comprises a presentation document, and each of the plurality of portions comprises a slide of the presentation document.

23. A non-transitory computer readable storage medium, having instructions stored therein, which when executed by a processing device of a computer system, cause the processing device to perform operations comprising:
receiving, by the processing device, a natural language text that comprises a plurality of text regions;
performing, by the processing device, natural language processing of the natural language text to determine one or more semantic relationships within the plurality of text regions;
generating, by the processing device, a search query to search for additional content related to at least one text region of the plurality of text regions, wherein the search query is based on results of the natural language processing for the at least one text regions;
transmitting the search query to one or more available information resources;
receiving a plurality of additional content items that each relate to a respective text region of the plurality of text regions in response to the search query; and
generating, by the processing device, a combined document comprising a plurality of portions, wherein each portion comprises one of the plurality of text regions, and at least one of the plurality of portions further comprising one or more of the plurality of additional content items that relate to a respective text region.

24. The non-transitory computer readable storage medium of claim 23, wherein performing natural language processing analysis of the natural language text further comprises:
performing semantico-syntactic analysis of the natural language text to produce a plurality of semantic structures, each semantic structure of the plurality of semantic structures representing a sentence of the natural language text;
identifying a first semantic structure of the plurality of semantic structures for a first sentence of the natural language text and a second semantic structure of the plurality of semantic structures for a second sentence of the natural language text; and
determining whether the first semantic structure is for the first sentence is semantically related to the second semantic structure for the second sentence based on a semantic proximity metric value.

25. The non-transitory computer readable storage medium of claim 24, the operations further comprising:
performing an information extraction operation comprising at least one of named entity recognition, image analysis, metadata analysis, or hashtag analysis.

26. The non-transitory computer readable storage medium of claim 24, the operations further comprising:
responsive to determining that the semantic proximity metric value is greater than or equal to a threshold value, assigning the first sentence and the second sentence to a first text region of the plurality of text regions.

27. The non-transitory computer readable storage medium of claim 24, the operations further comprising:
responsive to determining that the semantic proximity metric value is less than the threshold value, assigning the first sentence to a first text region of the plurality of text regions and the second sentence to a second text region of the plurality of text regions.

28. The non-transitory computer readable storage medium of claim 24, wherein the search query comprises at least one of a property of one of the sentences in the text region, a semantic class, a lexical class, a named entity, metadata, or a hashtag.

29. The non-transitory computer readable storage medium of claim 23, wherein the one or more available information resources comprises at least one of a local data store, a data store available via a local network, resource available via the Internet, or resources available via social network.

30. The non-transitory computer readable storage medium of claim 23, wherein the one or more additional content items comprises at least one of an image, a logo, a chart, a quotation, a joke, a video, an audio file, or textual content from a reference data source.

31. The non-transitory computer readable storage medium of claim 23, the operations further comprising:
ranking the additional content items based on attributes associated with a user profile to generate a sorted list;
prompting a user for a selection of one or more of the additional content items from the sorted list; and
generating the combined document using the selection.

32. The non-transitory computer readable storage medium of claim 22, the operations further comprising:
selecting one or more of the additional content items based on a priority profile; and
generating the combined document using the selection.

33. The non-transitory computer readable storage medium of claim 22, wherein the combined document comprises a presentation document, and each of the plurality of portions comprises a slide of the presentation document.
